(19) United States
(12) Patent Application Publication
(10) Pub. No.: US 2012/0222992 A1
(43) Pub. Date: Sep. 6, 2012

(54) POSTAL SORTING MACHINE INCLUDING NIPPING CONVEYOR MEANS, AND A METHOD OF USING THE MACHINE

(75) Inventors: Franck Girodet, Montelier (FR); Bruno Cartal, Montelier (FR)

(73) Assignee: SOLYSTIC, Gentilly Cedex (FR)

(21) Appl. No.: 13/390,438

(22) PCT Filed: Jun. 14, 2011
(86) PCT No.: PCT/FR11/51339

§ 371 Date: Feb. 14, 2012

(30) Foreign Application Priority Data
Aug. 19, 2010 (FR) 1056676

(51) Int. Cl. B07C 3/14

(52) U.S. Cl. 209/584

(57) ABSTRACT

This sorting machine comprises an unstacker (10) suitable for putting mailpieces on edge, address recognition means (20, 25) for recognizing the addresses of said mailpieces, and a conveying zone (2, 3, 4) for conveying the mailpieces by nipping them, which zone is made up of an unstacking zone (1) extending from the unstacker, and of a sorting zone (3) having a plurality sorting outlets (S1-SN), distributed from an upstream sorting outlet (S1) adjacent to the unstacker, to a downstream sorting outlet (SN). In accordance with the invention, said machine further comprises a recirculation zone (4) interconnecting the downstream sorting outlet (SN) and the upstream sorting outlet (S1), said recirculation zone co-operating with the unstacking zone (1) to define a point of confluence (C) situated between the unstacker and the upstream sorting outlet.

### TECHNICAL FIELD

The invention relates to a postal sorting machine including nipping conveyor means, and to a method of using such a machine. The invention relates more particularly to such a postal sorting machine that is suitable for sorting both large-format articles or “flats”, and also letters. The invention also relates to a method of using said sorting machine.

### PRIOR ART

In the postal field, mailpieces are categorized into various different types as a function their dimensions (height, length, and thickness) and of their weights. The different categories of mailpiece are defined in the ISO-269 Standard. For example, an envelope that can contain an A4-format or an A5-format sheet is a letter respectively having a C4 or a C5 format. A C4-format envelope has a width of 229 millimeters (mm) and a height of 324 mm. A C5-format envelope has a height of 162 mm and a width of 229 mm.

Currently, the spectrum of mailpieces that can be sorted automatically by machines covers mainly: letters up to the C5 format that are of thickness less than 8 mm and of weight no greater than 100 grams (g); and large-format flat articles or “flats” that can be even larger than letters of C4 format and above and of thickness that can be up to 32 mm and of weight than can be up to 2 kilograms (kg).

In general, nowadays, there exist both postal sorting machines that are dedicated to respective ones of those two types of mailpieces, namely letters or flats, and also postal sorting machines that are capable of processing both letters and flats.

Such a postal sorting machine conventionally comprises a feed inlet with an unstacker for putting the mailpieces into series and on edge, recognition means for recognizing the addresses on the mailpieces, and a conveyor that directs the mailpieces towards sorting outlets as a function of the addresses that are recognized. As is usual, the term “address” designates any inscription in the form of letters and/or of figures and/or of other signs that is present at the surface of a mailpiece with a view to identifying it.

The present invention applies more particularly to a conveyor system in which the mailpieces are caused to move by being nipped between two conveyor members, which are usually belts. For information, it is recalled that such conveying may be effected by means of bins, but that this does not apply in the present invention.

In a postal sorting machine with video-coding, the mailpieces go past optical acquisition means, constituted in general by a camera that takes a digital image of each mailpiece bearing address information. The digital image is processed in an automatic address evaluation system using Optical Character Recognition (OCR) and/or a Video-Coding System (VCS).

Such acquisition means, associated with such evaluation means, form address recognition means, in the meaning of the invention. When the address borne by the mailpiece can be recognized satisfactorily, said mailpiece is directed towards a corresponding sorting outlet of the machine.

Conventionally, it is possible to use two solutions, which may optionally be combined, in order to take charge of mailpieces having addresses that cannot be recognized in full.

Firstly, it is possible to perform “on-line” video-coding, by means of a delay line. In such a situation, the sorting machine incorporates a preliminary conveying zone, between the acquisition camera and the beginning of the sorting zone proper. The extra transit time taken for the mailpieces to travel along such a line makes it possible to process the mailpieces not recognized upstream.

Unfortunately, that first solution suffers from certain drawbacks, firstly related to the large floor area occupied by the delay line. That drawback is even more acute since it is necessary to be able to access the line, in order to clear any jams, and in order to do periodic maintenance operations on it.

In addition, said delay line tends to give rise to slippage of the mailpieces traveling along it, thereby requiring catching up that leads to rejects or jams. That phenomenon is, in particular, due to the difference between the respective coefficients of friction presented by mailpieces of different types, such as, for example, postcards and paper envelopes. That is prohibitive for a broad spectrum of mail, in which variations in thickness, in size, and in type of material are very significant.

In addition, in order to reduce their floor areas or “footprints”, delay lines often tend to follow very tight curves. That can damage the mail, or even make it impossible for certain types of mailpiece to pass, in particular when such mailpieces are of large size and/or of high stiffness.

Finally, all of the mailpieces follow that delay line even though, generally, only a small fraction require extra time in order to be recognized correctly. In another words, the majority of the mailpieces have their transit times increased unnecessarily.

A solution that is an alternative to the on-line video-coding presented above, is “off-line” video-coding. In off-line video-coding, the mailpieces that have not been recognized are marked, either physically with an identification code or ID Tag (time stamp), or virtually using the (V-Id)™ method developed by the Applicant.

Such mailpieces are then extracted via a sorting outlet that is specifically dedicated for them, with a view to them being stored temporarily. They are then fed back into the same sorting machine or into another sorting machine for subsequent processing.

Unfortunately, that second solution also suffers from drawbacks that are specific to it. Thus, it requires the mailpieces to be grouped together and to be stored, which involves reserving at least one specific sorting outlet, and occupying floor area.

In addition, given that the mailpieces are subjected to a second sorting pass, they are, in particular, subjected to additional unstacking, which constitutes an operation that is necessarily damaging. That can therefore give rise to double feeds being formed, i.e. to two mailpieces bunching together and going through together rather than singly, or can give rise to damage to the mailpieces. In addition, said second sorting pass involves an additional operation.

Publication US 2006/0 037 888 describes a postal sorting machine including a mailpiece unstacker for unstacking mailpieces, recognition means for recognizing the addresses of said mailpieces, and a conveying zone for conveying said mailpieces, which conveying zone has a main loop and shortened loops, enabling each mailpiece to be directed towards the sorting outlet to which it is to be sorted, without having to go all the way around the main loop. Unfortunately, that postal sorting machine does not make it possible to achieve full recognition during a first pass.

### SUMMARY OF THE INVENTION

An object of the invention is to remedy those various drawbacks. A particular object of the invention is to propose a sorting machine that, while presenting a small floor area or “footprint”, guarantees fast and effective processing of non-recognized mailpieces. An additional object is to propose such a sorting machine that is suitable for processing a broad spectrum of mailpieces, while also guaranteeing mechanical integrity for such mailpieces.

To these ends, the invention provides a postal sorting machine comprising an unstacker suitable for putting mailpieces on edge, address recognition means for recognizing the addresses of said mailpieces, and a conveying zone for conveying the mailpieces by nipping them, which zone is made up of an unstacking zone extending from the unstacker, and of a sorting zone having a plurality sorting outlets, distributed from an upstream sorting outlet adjacent to the unstacker, to a downstream sorting outlet, said postal sorting machine being characterized in that said machine further comprises a recirculation zone interconnecting the downstream sorting outlet and the upstream sorting outlet, said recirculation zone co-operating with the unstacking zone to define a point of confluence situated between the unstacker and the upstream sorting outlet, said machine further comprising synchronization means suitable for synchronizing the movements firstly of the “unstacked” mailpieces traveling between the unstacker and the point of confluence, and secondly of “recirculated” mailpieces traveling in the recirculation zone, these synchronization means comprising detection means for detecting the presence of at least one recirculated mailpiece, and control means suitable for acting on the unstacker in response to information transmitted by the detection means.

The basic idea of the invention is to use the sorting zone, equipped with its outlets, as a delay line. Under these conditions, it avoids the use of a specific segment for this delay line, as in the “on-line” solution. In addition, the invention does not require any sorting outlet specific to unrecognized outlets, as in the “off-line” solution.

It is to the credit of the Applicant to have identified that, in view of the very nature of the mailpiece, most mailpieces are correctly recognized at the beginning of their first pass through the sorting zone. Under such conditions, only a small fraction of the mailpieces are fed into the recirculation zone, which is not detrimental to the operational sorting capacity of the machine.

The conveying zone thus forms a loop, due to the presence of the above-mentioned recirculation zone. This thus makes it possible to direct the unrecognized mailpieces directly to upstream of the sorting zone, thereby avoiding any operation that might damage them.

This path for the mailpieces, along a loop, also offers other advantages, independently of those related to recognizing the mailpieces. Thus, assuming that a sorting outlet is unavailable, e.g. if it is fully filled, the mailpieces that are theoretically to be directed to it travel along the loop, until the sorting outlet is available again.

In addition, it happens sometimes that it is desirable for the mailpieces to be removed in a particular sequence, at a sorting outlet, but that said sequence is not correctly sequenced upstream from the unstacker. In such a case, only a fraction of the mailpieces are extracted during the first pass, and the remainder of the mailpieces are caused to travel at least once along the loop, in order to comply with the order of the sequence.

Finally, during operation of sorting, it can happen that the traces of certain mailpieces might be lost, or that they might have suffered acquisition problems. Under such conditions, those mailpieces are then recirculated, in such a manner as to go past the camera again.

The sorting machine of the invention may advantageously have the following features:
the detection means for detecting the presence of at least one recirculated mailpiece comprise two presence sensors disposed in the recirculation zone;
the unstacker is provided with a catch-up system, suitable for modifying the gap between two consecutive mailpieces;
the synchronization means further comprise speed variation means for varying the speed of at least one mailpiece traveling in the recirculation zone and optionally in the sorting zone;
the speed variation means comprise at least a first speed variation member placed in the recirculation zone, and optionally a second speed variation member placed in the sorting zone between two series of sorting outlets;
the first speed variation member is placed between the downstream presence sensor and the point of confluence;
the sorting zone has two straight branches interconnected by a U-turn;
the sorting zone has a length greater than 40 meters (m), and a number of sorting outlets greater than 100;
in the vicinity of the recirculation zone, the conveying zone substantially forms a U-turn having a length less than 2.5 m; and
the ratio between the length of the sorting zone and the length of the recirculation zone is considerably greater than 1, in particular greater than 10, and more particularly greater than 20.

The invention also provides a method of using the above sorting machine, wherein the mailpieces are unstacked by means of the unstacker, the recognition means are used in such manner as to recognize the addresses of said mailpieces, at least some of the mailpieces that have had their addresses correctly recognized are directed towards corresponding sorting outlets, and at least the mailpieces that have not had their addresses correctly recognized are caused to travel through the recirculation zone so that they are fed back into the sorting zone.

The method of the invention may advantageously have the following features:
the presence of at least one recirculated mailpiece is detected by detection means and action is taken on the stacker by using the control means, in such manner as to synchronize the respective movements of the unstacked mailpieces and of the recirculated mailpieces;
the mailpieces are unstacked with a constant gap and the unstacking is stopped so long as at least one recirculated mailpiece masks at least one of the two presence sensors;
an unstacker is used that is provided with a catch-up system, and the two presence sensors are spaced apart at a distance

D′(1−2)=(2×Gn+Lmax−Δd)

where Gn corresponds to the nominal gap between two mailpieces, Lmax corresponds to the maximum length of a mailpiece, and Δd is the difference between firstly the distance travelled, during the time taken to restart a mailpiece stopped at the unstacker, by a recirculated mailpiece traveling at the conveying speed, and secondly the distance for restarting a mailpiece stopped at the unstacker;
the gap between the trailing edge of a downstream unstacked mailpiece and the leading edge of an upstream recirculated mailpiece is identified, and an intermediate unstacked mailpiece is interposed between said downstream unstacked mailpiece, and said upstream recirculated mailpiece if the identified gap is greater than a theoretical minimum gap;
a recirculated mailpiece is interposed between two upstream and downstream unstacked mailpieces, and the speed variation means are used for accelerating the recirculated mailpiece so that it is distant from the downstream mailpiece by a gap that is as close as possible to a theoretical minimum gap, and the catch-up system is used so that the upstream mailpiece is distant from the recirculated mailpiece by a gap that is as close as possible to a theoretical minimum gap;
an unstacker is used that is provided with a catch-up system, the real gap between the trailing edge of a downstream unstacked mailpiece and the leading edge of an upstream recirculated mailpiece is identified, the theoretical minimum gap making it possible to interpose an intermediate unstacked mailpiece is determined, and the advance of the leading edge, between said real gap and said minimum gap, is identified, and if said advance is less than a maximum retard value allowed by the speed variation means, an intermediate unstacked mailpiece is interposed between said downstream unstacked mailpiece and said upstream recirculated mailpiece, and then the speed variation means are used to retard said recirculated mailpiece by a value corresponding to the advance of its leading edge;
the theoretical minimum gap corresponds to:

ds(1-3)=L2+Gmin(1-2)+Gmin(2-3)

where:

L2 is the length of the intermediate mailpiece; and

Gmin(1-2) and Gmin(2-3) are the minimum gaps to be complied with firstly between the trailing edge of the downstream mailpiece and the leading edge of the intermediate mailpiece, and secondly between the trailing edge of the intermediate mailpiece and the leading edge of the upstream mailpiece;
the speed variation means are used solely for slowing down the recirculated mailpieces, and the two presence sensors are spaced apart at a distance

D′(1-2)=(2×Gn+Lmax−Δd−Dret)

where:

Gn corresponds to the nominal gap between two mailpieces;

Lmax corresponds to the maximum length of a mailpiece; and

Δd is the difference between firstly the distance travelled, during the time taken to restart a mailpiece stopped at the unstacker, by a recirculated mailpiece traveling at the conveying speed, and secondly the distance for restarting a mailpiece stopped at the unstacker, and Dret is the maximum retard distance allowed by the speed variation means; and
upstream from the second speed variation member, two successive mailpieces that are to go through the recirculation zone are identified and, when at least one adjacent mailpiece that is adjacent to the two successive mailpieces has already been unloaded, the second speed variation member is used to space the two successive mailpieces apart.

### BRIEF DESCRIPTION OF THE DRAWINGS

The invention is described in more detail below, with reference to the accompanying drawings that are given merely by way of non-limiting example, and in which:

FIG. 1 is a highly diagrammatic plan view of a postal sorting machine of the invention;

FIG. 2 is a diagrammatic view, on a larger scale, of a portion of the postal sorting machine shown in FIG. 1;

FIG. 3 is a diagrammatic view, analogous to FIG. 2, of a first variant embodiment of a postal sorting machine of the invention;

FIG. 4 is a side view, on a larger scale, of an unstacker belonging to the sorting machine of FIG. 3;

FIGS. 5 and 6 are diagrammatic views of different uses of the sorting machine of FIGS. 3 and 4;

FIG. 7 is a diagrammatic view, analogous to FIG. 2, of a second variant embodiment of a postal sorting machine of the invention; and

FIGS. 8 to 11 are diagrammatic views showing different uses of the sorting machine of FIG. 7.

### DESCRIPTION OF EMBODIMENTS

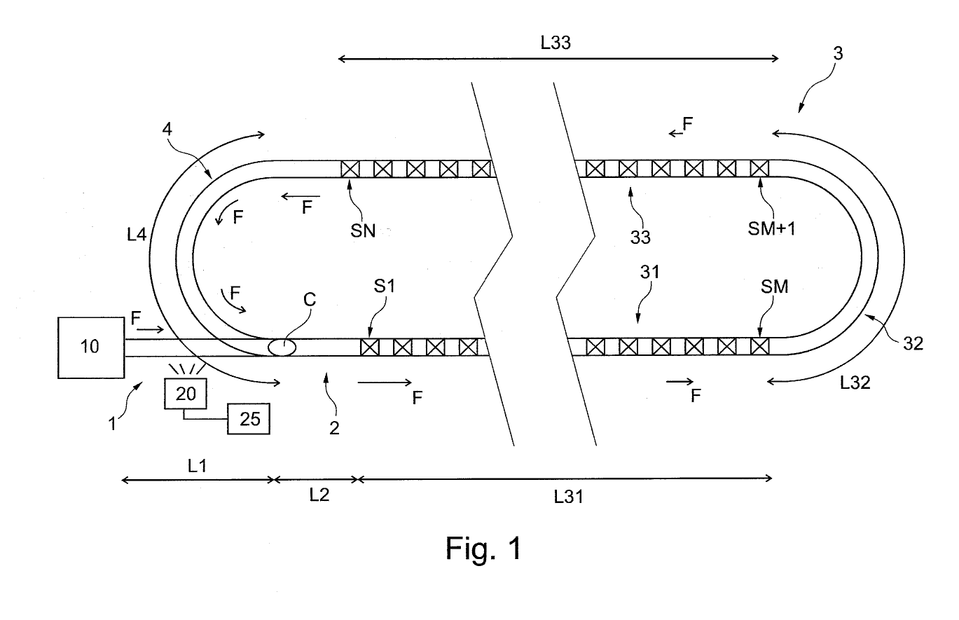

FIG. 1 shows a postal sorting machine for sorting mailpieces, which machine is shown diagrammatically. It is equipped with various members for conveying said mailpieces by nipping, in particular by means of usual belts. As mentioned above, the invention does not apply to conveyor means of the bin type or of an analogous type.

The sorting machine comprises an unstacking zone 1, a point of confluence C, an upstream intermediate zone 2, a sorting zone 3, and a recirculation zone 4. The path followed by the mailpieces is indicated by the arrows F in FIG. 1.

The unstacking zone, situated upstream from the point of confluence C, and the intermediate zone, situated between the point of confluence C and the first outlet S1 of the sorting zone, are of conventional type. In particular, the unstacking zone is equipped with an unstacker 10, of any suitable type.

In addition, one or other of these zones is provided with various items of equipment from among an image acquisition device 20, of the camera type, essential in the context of the present invention. Certain other items of equipment that are not shown are optional, namely, inter alia, a multiple-feed detector, a thickness measurement device, a stiffness detector, a device for rejecting mailpieces that are too stiff, bar code readers, or indeed printer devices.

It should be noted that, by construction, the unstacker 10 is situated in the unstacking zone 1. Whereas the other items of equipment mentioned above, in particular the camera 20, may be placed upstream or downstream from the point of confluence C.

Thus, placing the camera 20 in the unstacking zone 1, before the point of confluence C, is advantageous in terms of overall compactness. Whereas placing the camera 20 in the intermediate zone 2, after the point of confluence C enables the recirculated mailpieces to go back past the camera, thereby offering the possibility of additional acquisition of information.

In usual manner, the acquisition camera 20 is associated with evaluation means 25 that are shown diagrammatically. The combination of 20 and of 25 forms address recognition means, in the usual meaning thereof.

In non-limiting manner, the length L1 of the unstacking zone 1, between the outlet of the unstacker 10 and the point C, is advantageously less than the length of the recirculation zone 4. In addition, the length L2 of the intermediate zone 2, between the point C and the first sorting outlet S1, advantageously makes it possible to give a response of the OCR type, even when the image acquisition is situated after the point of confluence C. Otherwise, the first outlets might be non-usable. Under these conditions, this length has a minimum value that is advantageously greater than 4 m, i.e. a transit time of at least 1 second at maximum conveying speed.

The sorting zone 3, which is substantially U-shaped, is made up of two straight branches 31 and 33, and of one U-turn 32. The branch 31 is equipped with a first series of sorting outlets S1 to SM, while the branch 32 is equipped with a second series of sorting outlets SM+1 to SN, all of these outlets being of the conventional type.

The outlets, of which the total number N is advantageously greater than 40, are distributed substantially identically between the two series. References L31 and L33 designate the length of each branch, respectively between the outlets S1 and SM, and between the outlets SM+1 and SN, and L32 designates the length of the U-turn 32. The total length L3 of the sorting zone, which length corresponds to the sum of the lengths L31, L32, and L33, is advantageously greater than 40 m.

The recirculation zone 4 extends between the last outlet SN and the point of confluence C. It has a length L4 very considerably less than the total length L3 of the sorting zone. Thus, the ratio between L3 and L4 is advantageously greater than 10, in particular greater than 20. This makes it possible to guarantee that only a small fraction of the machine is not used for sorting the mailpieces.

The recirculation zone 4 defines a U-turn having a length L4 advantageously less than 2.5 m. In the example shown, this U-turn is fully formed by the recirculation zone. However, for example, if the unstacker faces in a different direction than as shown, the point of confluence C might be situated in the U-turn proper, and in general in the downstream portion thereof. In this situation, this U-turn of the conveying zone is then formed both by the recirculation zone 4 and by the intermediate zone 2.

In the above, a conveyor loop is described that is made up of two rectilinear segments 31 and 33, and by two U-turns 32 and 4. However, it is possible to make provision for each of these component elements to have a shape different from the shape described. It should be noted that it is, in any event, advantageous for the first and second sorting outlets S1 and SN to be close together, in order to impart a short length to the recirculation zone 4.

Use of the above-described postal sorting machine firstly involves, in conventional manner, the mailpieces being unstacked and then caused to go past a camera 20. The camera then, in a manner known per se, takes a digital image of each mailpiece, which image is processed by the evaluation means 25, also in usual manner. These operations make it possible, in most cases, for the addresses borne by the mailpieces to be recognized.

When the address is recognized correctly, the mailpiece in question is directed to a corresponding sorting outlet S1 to SN. When the address cannot be recognized in full, the mailpiece in question follows the conveyor loop beyond the last outlet SN, namely along the recirculation zone towards the point of confluence C.

Under such conditions, it can be understood that it is advantageous to provide means making it possible to synchronize the movements of the mailpieces traveling respectively in the unstacking zone 1 and in the zone 4 dedicated to recirculation. Such synchronization means firstly include means making it possible to detect the presence of a mailpiece, in the recirculation zone 4. In the example shown, these means are constituted by two sensors B1 and B2, of any appropriate type.

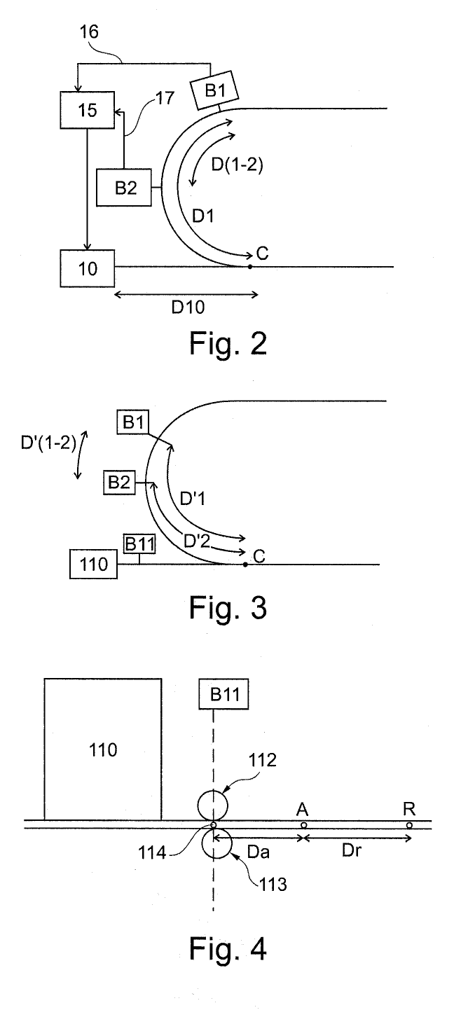

The detection means are associated with control means 15, shown only in FIG. 2 but preset in all of the embodiments. These control means are suitable for acting on the operation of the unstacker 10 in response to information delivered by the above sensors B1 and B2. Finally, as explained in more detail below, it is advantageously possible to provide means making it possible to modify the speed of the mailpieces in the recirculation zone, or indeed also in the sorting zone.

In general manner, the invention makes provision to slow down, or indeed to stop, the unstacking, when a mailpiece is detected in the recirculation zone. This operation can be completed by modifying the speed of said mailpiece, usually by braking it. This then makes it possible to interpose the recirculated mailpiece, in judicious manner, between two mailpieces coming from the unstacker.

It is assumed firstly that a first type of conventional unstacker is used, such as the unstacker equipping the Applicant's STAR sorting machine. That unstacker is suitable for unstacking the mailpieces with a constant gap, namely with a constant distance between the trailing edge of the downstream mailpiece and the leading edge of the upstream mailpiece. However, said unstacker is not capable of modifying the speed profile of an unstacked mailpiece.

In this situation, the two detection sensors B1 and B2 are spaced apart at a distance D,

D(1-2)=2×Gn+Lmax+Vc×t0

where:
Gn corresponds to the nominal gap between two mailpieces while they are being conveyed. This value, which is set a priori, is typically 95 mm for a letter, and 155 mm for a flat. When the machine is designed to process different types of mailpiece, the higher value is chosen.
Lmax corresponds to the maximum length of a mailpiece. This predetermined value is, for example, 328 mm, for a flat.
Vc is the nominal conveying speed.
t0 corresponds to the total time for suspending the unstacking.

In addition, the upstream sensor B1 is spaced apart from the point of confluence C, at a distance D1=D10+Vc×t0, where D is the distance between C and the outlet of the unstacker.

In service, when the upstream detector B1 detects the arrival of a mailpiece, it directs a signal, via the line 16, to the control means 15 that, in turn, act on the unstacker 10. The unstacker finishes unstacking the mailpiece being unstacked, and unstacking is then suspended.

Then, so long as a mailpiece is present between the two cells, or so long as a mailpiece is masking one of said cells, the unstacker is maintained in the suspended state. Then, when the trailing edge of the last mailpiece goes past the downstream sensor B2, said downstream sensor sends a corresponding signal, via the line 17, to the control means 15 that initiate resumption of unstacking.

In the second embodiment, shown with reference to FIGS. 3 to 6, another unstacker 110 is used that is of conventional type but that has additional functionality features relative to the above-described unstacker. This second unstacker, which, for example, complies with the teaching of French Patent 2 797 437, is provided with a catch-up system 112, shown diagrammatically in FIG. 4, suitable for modifying the gap between two successive unstacked mailpieces.

To this end, such an unstacker is equipped with at least one set of rollers 113, the speed of rotation of which is variable. The mailpiece passage zone defined by the upstream-most set of rollers is referred to as the “nip point” 114.

This unstacker is thus capable of instantaneously suspending the unstacking, under instruction from the monitoring-and-control means, and then of resuming it subsequently after an additional instruction. The advantage of this device is that it makes it possible to reduce the time for which the unstacking is interrupted, in comparison to the first type of unstacker presented above.

An additional sensor, referenced B11, is placed in register with the nip point 114. It should be noted that the length and the thickness of the mailpiece being unstacked are known when said mailpiece arrives at B11. In addition, as soon as said mailpiece masks B11, it cannot be stopped.

In addition, under nominal operating conditions, the duration of the stage during which B11 is masked by the mailpiece, namely the time taken by the mailpiece to go fully past B11, is predictable and controlled. It depends solely on the conveying speed and on the length of the mailpiece in question. It should be noted that, when its leading edge arrives in register with B11, the mailpiece is moved at said conveying speed.

Finally, the decision as to whether or not to stop a mailpiece is taken when its leading edge comes into register with B11. Stopping is implemented in compliance with a predetermined speed profile, making it possible to impart an identical stopping distance to all of the mailpieces. In addition, restarting is implemented in compliance with a speed profile that is also predetermined, making it possible to bring all of the mailpieces to the conveying speed, at the end of a distance and at the end of a length of time that are set previously. It should be noted that, although the stopping and restarting parameters are unvarying for a given sequence of the sorting machine, they may be modified from one sequence to another.

The various operating parameters are listed below with reference to FIG. 4 that shows the unstacker 110 on a larger scale:
Da is the stopping distance, necessary for stopping a mailpiece, from the instant at which its leading edge goes past B11.
A is the stopping point at which said mailpiece stops.
Dr is the restarting distance, necessary for bringing the mailpiece to its conveying speed, from the instant at which it is stopped at point A.
Tr is the restarting time, necessary for bringing the mailpiece to its conveying speed, from the instant at which it is stopped at point A.
R is the point at which the mailpiece resumes this nominal speed.
Δd is the difference between firstly the distance travelled during the length of time Tr by a recirculated mailpiece travelling at the conveying speed and secondly the restarting distance Dr. In other words Δd=Dr−(Vc×Tr).

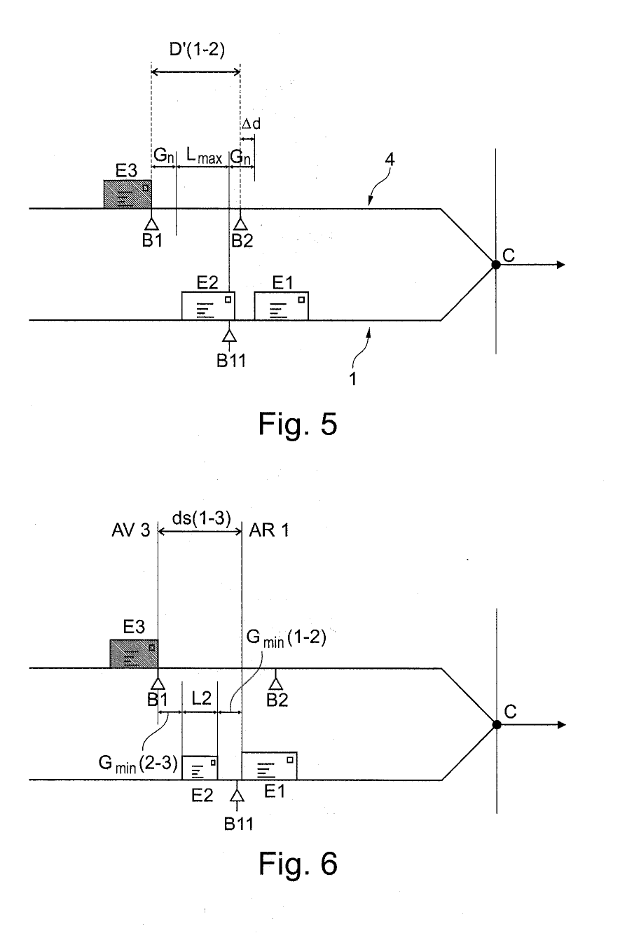

With reference to FIGS. 3 and 5, the two cells B1 and B2 are placed at respective distances D′1 and D′2 relative to the point C: D′1=D11+Lmax+Gn and D′2=D11−Gn−Δd, where D11 corresponds to the distance between B11 and C. It can thus be noted that the distance between the two cells is D′(1-2)=(2×Gn+Lmax−Δd), which is significantly shorter than in the first embodiment.

It is then assumed that two mailpieces E1 and E2 have been unstacked, while a recirculated mailpiece E3 finds itself in the zone 4. A first situation is shown in FIG. 5, in which, for reasons of clarity, the recirculation zone 4 is shown rectilinearly, above the unstacking zone 1.

In this situation, the mailpiece E2 has already masked the cell B11 while the leading edge of the recirculated mailpiece E3 is arriving in register with the cell B1. The drive for unstacking E2 is then not modified, so that E2 is directed normally towards the point of confluence C, in order to be interposed between E1 and E3.

In a second situation, shown in FIG. 6, it is assumed that the mailpiece E2 is still upstream from the cell B11, while the leading edge of the recirculated mailpiece E3 is arriving in register with the cell B1. Even though it might then be assumed that it is not possible to interpose E2 between E1 and E3, it can be made possible under certain conditions.

Thus, the empty space existing between E1 and E3 is potentially sufficient if:

d(1-3)≧ds(1-3)=L2+Gmin(1-2)+Gmin(2-3)

let this be condition (I), where:
d(1-3) is the real gap between E1 and E3, namely the distance between the trailing edge AR1 of E1 and the leading edge AV3 of E3;
ds(1-3) designates the threshold value for said gap; in FIG. 6, d(1-3) is shown equal to ds(1-3);
L2 is the length of the mailpiece E2; and
Gmin(1-2) and Gmin (2-3) are the minimum gaps to be complied with firstly between the trailing edge of E1 and the leading edge of E2, and secondly between the trailing edge of E2 and the leading edge of E3. These gaps are to be understood as being with reference to the mailpieces as placed one behind the other in the sorting zone.

The values for Gmin may, by default, be taken to be equal to Gn. However, in order to increase the productivity of the sorting sequence, it is possible to choose a value for Gmin that is less than Gn. The person skilled in the art may assign any suitable value to Gmin as a function, in particular, of the following parameters:
Length and thickness of the pair of adjacent mailpieces, E1 and E2, or indeed E2 and E3;
Slippage of the recirculated mailpiece E3, observed while it is traveling along the sorting zone;
Distance remaining to be travelled by E3 in order to reach its sorting outlet; and
Any coefficient making it possible to introduce a safety margin.

If above condition (I) is satisfied, the mailpiece E2 is then injected in usual manner via the nip point, namely without stopping. If said condition (I) is not satisfied, said mailpiece E2 is stopped, until the trailing edge of the recirculated mailpiece E3 goes past the cell B2, as in the first embodiment.

In the third embodiment, at least one Gap Management Device (GMD) is used, which device is suitable for modifying the speed of a mailpiece in the recirculation zone, or indeed upstream in the sorting zone. For example, such a device equips the Applicant's STAR sorting machine. In preferred manner, it is associated with an unstacker provided with a catch-up system, such as the system 110 used in the second embodiment described immediately above.

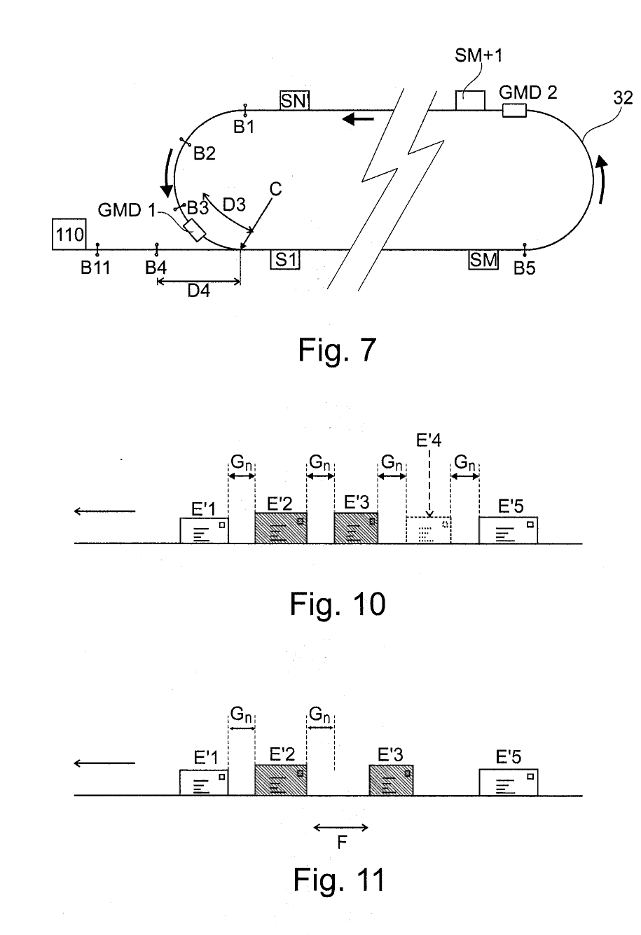

A first gap management device, referenced GMD1 and referred to as “GMD1” below for reasons of convenience, is placed in the recirculation zone 4 between the downstream detection cell B2 and the point of confluence C. GMD1 is controlled, inter alia, by means of two additional cells B3 and B4. One of them (B3) is disposed in the recirculation zone, between the cell B2 and GMD1 proper, while the other cell B4 is provided in the unstacking zone. These two cells B3 and B4 are equidistant from the point of confluence C, namely the distances D3 and D4 in FIG. 7 are identical.

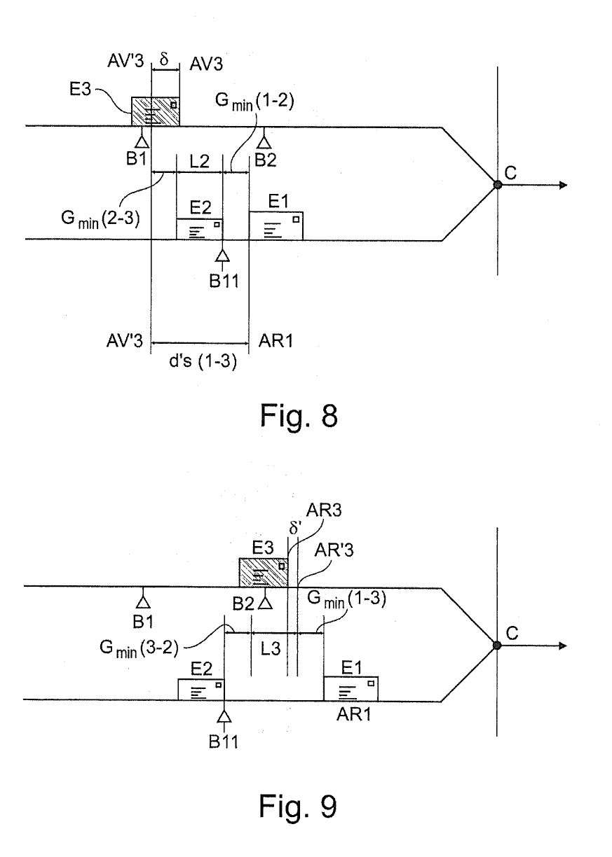

With reference to FIGS. 8 and 9, a first type of use of GMD1 is described below, in which use GMD1 is suitable both for slowing down and for accelerating a recirculated mailpiece. In such a situation, the distance between the cells B1 and B2 is identical to the distance in the second embodiment above, namely (2×Gn+Lmax−Δd). It is explained below that, in another embodiment, this distance may be reduced.

FIGS. 8 and 9 show the progress of two unstacked mailpieces E1 and E2, and of a recirculated mailpiece E3. As a function of the phase offset between E2 and E3, firstly it is necessary to choose which of the mailpieces is to be directed before the other one towards the point of confluence C.

In FIG. 8, the recirculated mailpiece E3 is significantly retarded relative to E2, so that it appears judicious to be able to interpose E2 between E1 and E3.

As in the second embodiment, it is known that this is possible if condition (I) is satisfied, namely: d(1-3)≧ds(1-3).

The use of the GMD makes it possible, where applicable, to interpose E3, even if said condition (I) is not satisfied. The GMD has a characteristic distance Dret that corresponds to the maximum retard that the GMD can impart to a mailpiece, by decelerating it. Thus, account is then taken of condition (I bis) that can be written:

d(1-3)≧d's(1-3)=L2+Gmin(1-2)+Gmin(2-3)−Dret

In FIG. 8, AR1 designates the position of the trailing edge of E1, AV3 designates the real position of the leading edge of E3, AV′3 designates the theoretical position of said leading edge in order to satisfy condition (I bis), and δ designates the advance of the trailing edge of E3 relative to said theoretical position. If δ is less than Dret, it is known that the GMD can then retard the mailpiece E3 by a value such that E3 can be repositioned at AV′3. There is then sufficient space between E1 and E3 to allow E2 to be interposed, so that normal injection of said mailpiece E2 is authorized.

Then, during its progress along the recirculation zone, E3 is retarded by the distance 5, so that its leading edge is spaced apart from the trailing edge of E2 by the gap Gmin (2-3). In practice, Gmin(2-3) is caused to tend towards Gn, insofar as possible. This retard is used in conventional manner, by using the cells B3 and B4.

Conversely, when 5 is greater than Dret, the mailpiece E2 is stopped, until E3 no longer masks the cell B2.

It can be seen, as shown in FIG. 9, that the recirculated mailpiece E3 is retarded relative to E1, by a distance that is relatively small, so that it appears judicious to interpose E3 between E1 and E2. It is also known that condition (I) as applied to this situation, must be satisfied, namely:

d(1-2)≧ds(1-2)=L3+Gmin(1-3)+Gmin(3-2)

where:

d(1-2) is the gap between E1 and E2, namely the distance between the trailing edge of E1 and the leading edge E2;

L3 is the length of the mailpiece E3; and

Gmin(1-3) and Gmin(3-2) are the minimum gaps to be complied with firstly between the trailing edge of E1 and the leading edge of E3 and secondly between the trailing edge of E3 and the leading edge of E2. As above, Gm(1-3) and Gmin (3-2) are caused to tend towards Gn, insofar as possible.

In FIG. 9, AR1 designates the position of the trailing edge of E1, AV3 designates the real position of the leading edge of E3, AV′3 designates the theoretical position of said leading edge for complying with the minimum gap Gmin (1-3), and δ′ designates the retard of the leading edge E3 relative to said theoretical position.

The user of the GMD makes it possible to advance E3, in order to bring it closer to this theoretical position, which is advantageous in terms of productivity. It is known that the GMD has another characteristic distance Dav, which corresponds to the maximum advance that the GMD can impart to a mailpiece, by accelerating it.

Under these conditions, if δ′ is less than Dav, E3 is accelerated so that it is positioned as close as possible to E1, in order to comply with the minimum gap Gmin (1-3). Conversely, if δ′ is greater than Dav, E3 is accelerated so as to bring it closer to said above-mentioned maximum value Dav, while it remains distant from E1 by a gap greater than Gmin (1-3).

In addition, the minimum gap Gmin (3-2) between E3 and E2 must be complied with. To achieve this, the catch-up system 112 of the unstacker 110 is used, so as to defer progress of E2 and to space it apart from E3 in suitable manner. The gap between E2 and E3 is computed by taking account of the position that E3 will occupy once it has been advanced by the value δ′ or Dav as explained above, rather than taking account of the real position of E3.

The second type of use of the GMD1 or “simplified use”, is based on the very nature of such a GMD. It is known that a GMD offers much higher performance in terms of accuracy and of amplitude when applying a deceleration to a mailpiece rather than an acceleration.

Under these conditions, the GMD1 is used solely in deceleration mode, thereby making it possible to place the cell B1 closer to the point of confluence, by a distance Dret. Consequently, the distance between the two cells is further reduced, because it is then as follows: D″(1-2)=(2×Gn+Lmax−Δd−Dret). This second type of use (not shown in the figures) is conducted in the same way as the first mode in its “deceleration” version shown in FIG. 8.

The advantages of the various embodiments presented above appear clearly from the above.

Thus, the first embodiment can be implemented simply, by using a conventional and robust unstacker. The distance D(1-2) between the cells B1 and B2 is then typically 1393 mm, when Gn=155 mm, Lmax=328 mm, Vc=3.5 meters per second (m/s), and t0=0.215 seconds. This distance D is important because on it depends the time for which unstacking is interrupted, unstacking being suspended so long as a recirculated mailpiece masks one of the cells.

The second embodiment makes it possible to reduce the value of this distance by using the fact that the unstacker provided with means for catching up the gap is suitable for suspending unstacking and for resuming it immediately. Therefore, for the same values of Lmax and Gn, the distance D′(1-2) can be reduced to 650 mm, i.e. a reduction of more than 50% relative to the first embodiment. The use of such an unstacker also makes it possible not to stop the unstacking, under certain circumstances under which the first embodiment of the unstacker would have required unstacking to be suspended, such as, in particular, in the situation shown in FIG. 6.

The third embodiment makes it possible to catch up the positions of the recirculated mailpieces, thereby avoiding suspending the unstacking in certain situations. Thus, if the position of the recirculated mailpiece is such that it will be too close to an adjacent unstacked mailpiece at the point of confluence, the position catch-up ensures that it has a sufficient gap with the adjacent mailpiece, with a view to allowing them to be put in series downstream from the point of confluence. In addition, conversely, it is possible to bring a recirculated mailpieces closer to an adjacent unstacked mailpiece if they are initially too far apart, for reasons of productivity.

In addition, in the variant of the third embodiment in which only deceleration is used, it is possible to place the two cells B1 and B2 closer together. Thus for the same values of Lmax and of Gn as above, the distance D′ (1-2) is brought to 450 mm, i.e. to less than one third of the base value.

It should be noted that, optionally, it is possible to place another GMD, referenced GMD2, between the two series of sorting outlets, namely at the U-turn 32. More precisely, GMD2 is typically placed in the downstream portion of said U-turn while the sensor B5, which controls GMD2, is disposed in the upstream portion of the U-turn.

Using the second GMD involves identifying, at the U-turn, mailpieces to be recirculated. In FIG. 10, such mailpieces are the mailpieces E′2 and E′3, which are spaced apart by a nominal gap Gn measured by the cell B5.

When at least one of the mailpieces E′1 and E′4 adjacent to said mailpieces to be recirculated has already been unloaded into a sorting outlet, it is possible to modify the speed of E′2 or E′3. This makes it possible to increase the gap between the two mailpieces, while also maintaining a suitable gap with the adjacent mailpieces.

In the example shown, it is assumed that E′4 has already been discharged at the first series of sorting outlets, which explains why it is shown in dashed lines. GMD2 then slows E′3 down, so as to space it further apart from E′2, as indicated by the double-headed arrow F in FIG. 11, while also keeping the following mailpiece E′5 at the suitable distance. In addition, the gap between E′1 and E′2 is unchanged.

1-20. (canceled)

21. A postal sorting machine comprising:
an unstacker suitable for putting mailpieces on edge;
address recognition means for recognizing the addresses of the mailpieces;
a conveying zone for conveying the mailpieces by nipping them, which zone is made up of an unstacking zone extending from the unstacker, and of a sorting zone having a plurality sorting outlets, distributed from an upstream sorting outlet adjacent to the unstacker, to a downstream sorting outlet;
a recirculation zone interconnecting the downstream sorting outlet and the upstream sorting outlet, said recirculation zone co-operating with the unstacking zone to define a point of confluence situated between the unstacker and the upstream sorting outlet; and
synchronization means suitable for synchronizing the movements firstly of the “unstacked” mailpieces traveling between the unstacker and the point of confluence, and secondly of “recirculated” mailpieces traveling in the recirculation zone, said synchronization means including detection means for detecting the presence of at least one recirculated mailpiece, and control means suitable for acting on the unstacker in response to information transmitted by the detection means.

22. A machine according to claim 21, wherein the detection means for detecting the presence of at least one recirculated mailpiece includes two presence sensors disposed in the recirculation zone.

23. A machine according to claim 21, wherein the unstacker includes a catch-up system, suitable for modifying the gap between two consecutive mailpieces.

24. A machine according to claim 22, wherein the synchronization means further includes speed variation means for varying the speed of at least one mailpiece traveling in the recirculation zone and optionally in the sorting zone.

25. A machine according to claim 24, wherein the speed variation means includes at least a first speed variation member placed in the recirculation zone, and optionally a second speed variation member placed in the sorting zone between two series of sorting outlets.

26. A machine according to claim 25, wherein the first speed variation member is placed between the downstream presence sensor and the point of confluence.

27. A machine according to claim 21, wherein the sorting zone has two straight branches interconnected by a U-turn.

28. A machine according to claim 27, wherein the sorting zone has a length greater than 40 m, and a number of sorting outlets greater than 100.

29. A machine according to claim 21, wherein, in the vicinity of the recirculation zone, the conveying zone substantially forms a U-turn having a length less than 2.5 m.

30. A machine according to claim 29, wherein the ratio between the length of the sorting zone and the length of the recirculation zone is greater than 1.

31. A method of using the sorting machine according to claim 21, wherein the mailpieces are unstacked by means of the unstacker, the recognition means are used in such manner as to recognize the addresses of said mailpieces, at least some of the mailpieces that have had their addresses correctly recognized are directed towards corresponding sorting outlets, and at least the mailpieces that have not had their addresses correctly recognized are caused to travel through the recirculation zone so that they are fed back into the sorting zone.

32. A method according to claim 31, wherein the presence of at least one recirculated mailpiece is detected by detection means and action is taken on the stacker by using the control means, in such manner as to synchronize the respective movements of the unstacked mailpieces and of the recirculated mailpieces.

33. A method according to claim 31, wherein the mailpieces are unstacked with a constant gap and the unstacking is stopped so long as at least one recirculated mailpiece masks at least one of two presence sensors.

34. A method according to claim 31, wherein an unstacker with a catch-up system is used to unstack the mailpieces, and wherein two presence sensors disposed in the recirculation zone are spaced apart at a distance
D′(1-2)=(2×Gn+Lmax−Δd)
where Gn corresponds to the nominal gap between two mailpieces, Lmax corresponds to the maximum length of a mailpiece, and Δd is the difference between firstly the distance travelled, during the time take to restart a mailpieces stopped at the unstacker, by a recirculated mailpiece traveling at the conveying speed, and secondly the distance for restarting a mailpiece stopped at the unstacker.

35. A method according to claim 31, further comprising identifying the gap between the trailing edge of a downstream unstacked mailpiece and the leading edge of an upstream recirculated mailpiece, and interposing an intermediate unstacked mailpiece between said downstream unstacked mailpiece and said upstream recirculated mailpiece if the identified gap is greater than a theoretical minimum gap.

36. A method according to claim 31, further comprising interposing a recirculated mailpiece interposing between two upstream and downstream unstacked mailpieces, and the using speed variation means for accelerating the recirculated mailpiece so that it is distant from the downstream mailpiece by a gap that is as close as possible to a theoretical minimum gap, and using the catch-up system so that the upstream mailpiece is distant from the recirculated mailpiece by a gap that is as close as possible to a theoretical minimum gap.

37. A method according to claim 31, further comprising using an unstacker that is provided with a catch-up system, determining the real gap between the trailing edge of a downstream unstacked mailpiece and the leading edge of an upstream recirculated mailpiece, identifying the theoretical minimum gap making it possible to interpose an intermediate unstacked mailpiece, and identifying the advance of the leading edge, between said real gap and said minimum gap, and if said advance is less than a maximum retard value allowed by the speed variation means, interposing an intermediate unstacked mailpiece between said downstream unstacked mailpiece and said upstream recirculated mailpiece, and then using the speed variation means to retard the recirculated mailpiece by a value corresponding to the advance of its leading edge.

38. A method according to claim 35, wherein the theoretical minimum gap corresponds to:
ds(1-3)=L2+Gmin(1-2)+Gmin(2-3)
where:
L2 is the length of the intermediate mailpiece; and
Gmin(1-2) and Gmin(2-3) are the minimum gaps to be complied with firstly between the trailing edge of the downstream mailpiece and the leading edge of the intermediate mailpiece, and secondly between the trailing edge of the intermediate mailpiece and the leading edge of the upstream mailpiece.

39. A method according to claim 31, further comprising using speed variation means to slow down the recirculated mailpieces, and wherein two presence sensors are disposed in the recirculation zone spaced apart at a distance
D′(1-2)=(2×Gn+Lmax−Δd−Dret)
where:
Gn corresponds to the nominal gap between two mailpieces;
Lmax corresponds to the maximum length of a mailpiece; and
Δd is the difference between firstly the distance travelled, during the time taken to restart a mailpiece stopped at the unstacker, by a recirculated mailpiece traveling at the conveying speed, and secondly the distance for restarting a mailpiece stopped at the unstacker, and Dret is the maximum retard distance allowed by the speed variation means.

40. A method according to claim 39, wherein, upstream from the second speed variation member, two successive mailpieces that are to go through the recirculation zone are identified and, when at least one adjacent mailpiece that is adjacent to the two successive mailpieces has already been unloaded, the second speed variation member is used to space the two successive mailpieces apart.

41. A machine according to claim 29, wherein the ratio between the length of the sorting zone and the length of the recirculation zone is greater than 10.

42. A machine according to claim 29, wherein the ratio between the length of the sorting zone and the length of the recirculation zone is greater than 20.
